(19) United States
(12) Patent Application Publication
(10) Pub. No.: US 2007/0115221 A1
(43) Pub. Date: May 24, 2007

(54) Full-color organic display with color filter technology and suitable white emissive material and applications thereof

(76) Inventors: Dirk Buchhauser, Regensburg (DE); Debora Henseler, Erlangen (DE); Karsten Heuser, Erlangen (DE); Wolfgang Rogler, Moehrendorf (DE)

Correspondence Address: FISH & RICHARDSON P.C., PO BOX 1022, MINNEAPOLIS, MN, 55440-1022, US

(21) Appl. No.: 10/579,132

(22) PCT Filed: Nov. 12, 2004
(86) PCT No.: PCT/DE04/02509

§ 371 Date: May 12, 2006

(30) Foreign Application Priority Data
Nov. 13, 2003 (DE) 103 53 036.3

(51) Int. Cl. G09G 3/30

(52) U.S. Cl. 345/76

(57) ABSTRACT

The invention relates to a color organic display (OLED display) with pixels (1), which comprise in each case a subpixel set (2, 3, 4) with the colors, red, green, and blue, having:
a substrate (5), which is at least partially transparent to visible light,
a structured color filter (6), which generates the colors of the subpixels (2, 3, 4) and is subsequently arranged on the substrate (5),
a first electrode (7, 9) subsequently arranged on the color filter (6), which is at least partially transparent to visible light,
at least one active layer (8) subsequently arranged on the first electrode (7, 9), containing an emissive material, which is suitable for the generation of electromagnetic radiation, whose spectrum is matched to the color filter (6) such that the pixels (1) during control with the same electrical signal emit light whose color location lies within the white region of the CIE diagram, and
a second electrode (7, 9) subsequently arranged on the active layer (8).

The invention relates to a full-color organic illuminated display (organic light emitting diode display, abbreviated as “OLED display”) with improved color stability, particularly an illuminated display in which the colors are generated by color filters, which are arranged before an emitter. In addition, the invention relates to the use of such OLED displays, for example, in the field of communication, automotive sector, consumer electronics, business, medical technology, industrial electronics, or household appliances.

OLEDs are known, for example, for the generation of full-color displays, which are constructed as follows: An emissive layer is applied to an ITO (indium tin oxide)-coated substrate, often to an additional planarizing and/or hole-transporting intermediate layer. The emissive layer can be structured either as pixels (individual points) and consist of various emissive materials (typically red, green, and blue) or of a uniformly emissive material, whereby the individual color pixels are created by upstream color filters (color filter technology). In order to achieve hereby a predefined color (e.g., the white point) on the display, the subpixels of the individual colors are driven with a certain current ratio, which depends on the emissive material and color filters.

All colors that a human being can perceive are defined, for example, by an area on the so-called CIE diagram. Within this area, segments or subsets can be delimited, which localize the colors sufficient for creating a full-color display. This subset in each case comprises the so-called white point at which the number and intensity of the specific subpixels are selected in such a way that the color white is emitted.

In order to achieve a white emission in organic light-emitting diodes, for example, in current full-color displays with structured emissive layers, the subpixels, red, green, and blue, are driven with a intensity ratio of 1.2 (red) to 1 (green) to 1.8 (blue). In other words, the blue subpixels are driven with almost double the current density as the green subpixels. With the requirement that in current applications of full-color displays on average the individual subpixel sets are operated such that the white point is rendered as the average color, the blue subpixels age about twice as fast as the green ones. As a result, the actually displayed color changes in an aging display.

An object of the present invention, therefore, is to create a full-color display in which constant colors are retained over the entire lifetime of the organic display with color filter technology.

This object is achieved by a color display with the features of claim 1. Advantageous improvements and applications are described in the dependent claims.

The subject of the invention is a color organic display (OLED display) with pixels, which comprise in each case a subpixel set with the colors, red, green, and blue, having:
a substrate, which is at least partially transparent to visible light,
a structured color filter, which generates the colors of the subpixels and is subsequently arranged on the substrate,
a first electrode subsequently arranged on the color filter, which is at least partially transparent to visible light,
at least one active layer subsequently arranged on the first electrode, containing an emissive material which is suitable for the generation of electromagnetic radiation, whose spectrum is matched to the color filter such that the pixels during control with the same electrical signal emit light whose color location lies within the white region of the CIE diagram, and
a second electrode subsequently arranged on the active layer.

In a preferred embodiment, the first electrode functions as an anode and comprises indium tin oxide (ITO), because ITO is a material with a high work function for electrons and is substantially transparent to visible light.

According to the present invention, the subpixels comprise all of the same emissive material and the different color impression, red, green, and blue, is generated by a structured color filter. The color filter is structured such that within the range of the subpixel transmission for visible light it exhibits the color desired in each case. Compared with color displays with subpixels from emitters having a different color, this offers production-related advantages, because only one material needs to be processed. Furthermore, during use of a uniform emissive material, it does not matter for the quality of the display if the emissive material from different subpixels is slightly mingled.

According to the invention, a custom-made broadband emitter, which is matched in each case to the transmission of the color filter, is employed. This combination makes it possible for the first time to drive all three subpixel sets with the same current or intensity or brightness and thereby to overcome the problem of the different aging/lifetime of the subpixel sets, which exists thus far both in the inkjet printing techniques and in the broadband emitters, which are applied to a large surface and emit different colors by means of a color filter, and causes major difficulties in the realization of full-color displays. Based on the different transmission of the individual color filters, these subpixels according to the state of the art are all driven with a different current intensity.

Because the emissive material is configured to the spectrum of the color filter such that all subpixels can be driven with the same electrical signal, the active material of emissive layer ages uniformly. Advantageously, therefore, the color impression of the display remains substantially constant during the operating time.

Driving the three subpixel sets with same current achieves that the pixels of a full-color display during average uniform control of the different colors have approximately the same lifetime.

The current density employed for a pixel during operation has a direct effect on the lifetime of emissive material. Thus, the lifetime of a pixel declines by at least a factor of 2, if the brightness of the pixel is increased by raising the current density by the factor of 2.

An OLED display whose individual subpixels of the subpixel set, red, green, and blue, have the same lifetime is the subject of the invention.

In an embodiment of the color organic display, the emissive material contains polymers with first chromophores, which give a green color impression, and second chromophores which give a red color impression. The first (green) chromophores and the second (red) chromophores can be blended into the polymer (so-called polymer blends) or be coupled covalently to said polymer.

Preferably, in this embodiment, blue-emitting polymers are used as the emissive material, such as, for example, polyspiro or polyfluorene compounds, to which the red and green chromophores are coupled covalently. White-emitting copolymers are produced by the covalent coupling of red and green chromophores to the blue-emitting polymers.

It is also conceivable to couple the chlomophores to different polymers and to combine these. The portion of the specific chromophores is preferably selected so that the emission spectrum of the emissive material is matched to the transmission spectrum of the color filter so that the subpixels can be controlled with the same electrical signal.

In a preferred embodiment of the color organic display, the emissive material contains furthermore chromophores, which produce a blue color impression. With the aid of additional blue chromophores, the emission spectrum of the emissive material can be matched especially simply and precisely to the transmission spectrum of a color filter to generate red, green, and blue subpixels.

Finally, the subject of the invention is the use of an organic display with color filter technology according to the invention, for example, in the field of communication, automotive sector, consumer electronics, business, medical technology, industrial electronics, or household appliances.

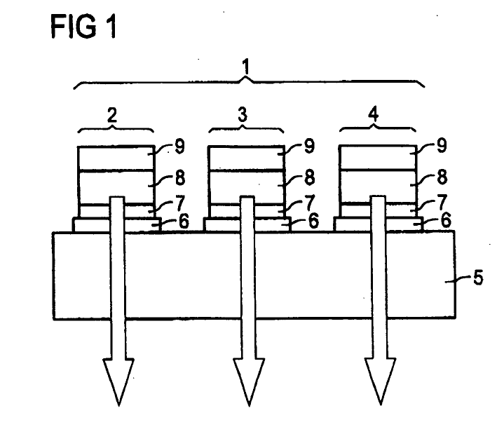

The invention will be explained below with use of the following exemplary embodiments in conjunction with FIGS. 1 through 4 and 5a through 5d.

The figures show:

FIG. 1, a schematic sectional view through a color display according to the invention,

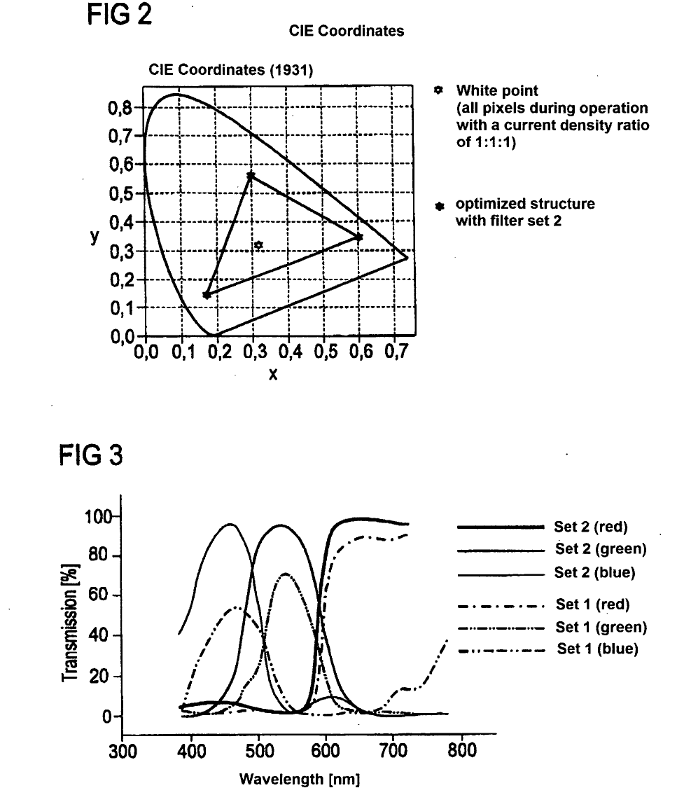

FIG. 2, the CIE diagram,

FIG. 3, transmission spectra of two filter sets #1 and #2,

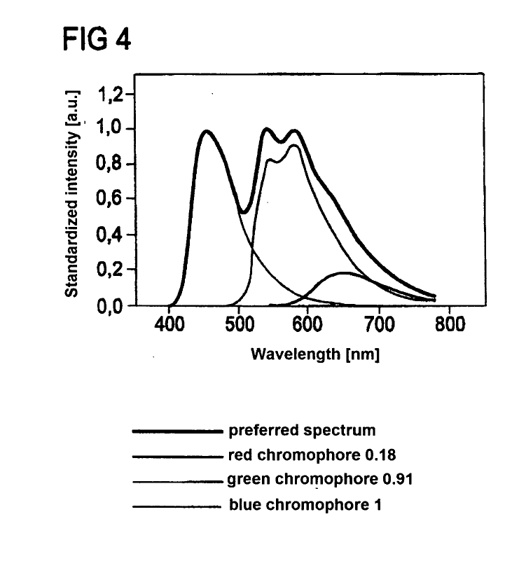

FIG. 4, the emission spectrum of a broadband emitter with red and green chromophores, which are coupled covalently to a blue-emitting polymer, and

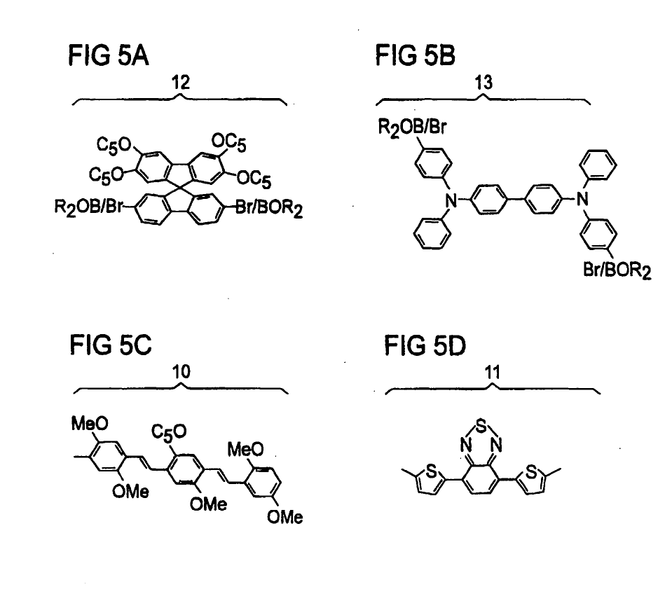

FIGS. 5a through 5d, chemical structures of the color-imparting subunits and a hole-transporting subunit of an emissive material.

In the exemplary embodiments and the figures, the same components or those with a similar function are each provided with the same reference characters. The depicted elements of the figures, particularly the layer thicknesses, are not to be regarded as drawn to scale. Rather, for better understanding, they can be depicted excessively large in some instances.

In the exemplary embodiments according to FIG. 1, a pixel 1 of the color organic display divides into a red 2, a green 3, and a blue 4 subpixel. To this end, a structured color filter 6 is applied to a substrate 5. The substrate 5 is substantially transparent to visible light and consists, for example, of glass. Particularly for flexible applications, however, it is also possible to use substrates of transparent plastics, such as, for example, poly(ethylene terephthalate) (PET), poly(butylene terephthalate) (PBT), poly(ethylene naphthalate) (PEN), polycarbonate (PC), polyimide (PI), polysulfone (PSO), poly(p-phenylene ether sulfone) (PES), polyethylene (PE), polypropylene (PP), poly(vinyl chloride) (PVC), polystyrene (PS), and poly(methyl methyl acrylate) (PMMA).

The structured color filter 6 has different fields, each of which transmit light with the desired color of subpixel 2, 3, 4. These fields comprise, for example, polyacrylates, which are provided with pigments to produce the desired color impression. These materials can be applied, for example, wet chemically by means of photolithographic processes.

An anode 7 of indium tin oxide (ITO) is applied to the structured color filter 6. This can cover the entire surface or be made structured, for example, according to the fields of the color filter 6. ITO is applied, for example, by sputtering.

An active layer 8, comprising an emissive material, is then placed on the anode 7. The active layer 8 is followed by a cathode 9, which is fabricated preferably of a material with a low work function for electrons. Cathode 9 can comprise, for example, magnesium or calcium. It is also possible to arrange additional layers, such as, for example, hole-transporting or electron-transporting layers between the active layer 8 and the. electrodes.

FIG. 2 shows the CIE coordinates for all colors visible to humans and as a detail therefrom a triangle, which encloses approximately the set of colors that, for example, a color television set is to be capable of reproducing according to current requirements.

This subset covers the so-called white point, which according to definition lies at the CIE coordinates x=0.33/y=0.33. A measure for the uniformity of the color reproduction in a full-color display is the removal of the mixing point, which arises during the same control of the subpixel sets, from the white point.

For most of the conventional color filter systems, it is desirable that the emissive material is matched so that the red-green-blue (RGB) mixing point lies on the white point (x=0.33/y=0.33) during uniform control (FIG. 2). Depending on the transmission spectrum of the filter, however, another color location can also be sought.

FIG. 3 shows the transmission of two color filter sets 6 for red, green, and blue; the dashed line shows a mutually matched combination of emissive material and a filter set #1, which consists of commercial filters.

The solid lines in. FIG. 3 reflect the transmission of a mutually matched combination of emissive material and filter set #2 (comprising red, green, and blue), which with uniform control, thus the same driver conditions, together generate white at point (0.33; 0.33).

Filter set #2 was optimized in regard to better transmissibility, so that at the same current density a higher transmission makes possible a higher brightness. For filter set #1 (see FIG. 3, there, the dashed lines), a selection of commercial filters was selected.

FIG. 4 shows an organic emitter emission spectrum matched to color filter set #2. The emissive material has a broadband emission spectrum, which, for example, comprises three broadband components, red, green, and blue, with maxima at about 450, 580, and 640 nm.

The emission characteristic shown in FIG. 4 is obtained, for example, with organic emissive materials (based on small molecules or polymers, and blends or copolymers there), which are made of red-, green-, and blue-emitting structural elements. Known, inter alia, are other polyspiro compounds or polyfluorenes, which in addition to these red-, green-, and blue-emitting structural elements have, for example, a broadband emission characteristic shown in FIG. 3. The material contains the at least three chromophores 10, 11, 12 either in the form of polymers and/or blends of polymers and copolymers thereof or in the form of small molecules. Small molecules are, for example, applied by a vaporization technique, whereas the polymeric emissive materials, for example, are applied by spin coating or printing techniques.

An adjustment of the chromophore ratios to the color filter set 6 according to the present invention leads to an optimal ratio of the peak intensities from 0.18 (red) to 0.91 (green) to 1 (blue) for filter set #2.

Copolymers, which comprise the following color-imparting subunits (chromophores) 10, 11, 12, are employed as the broadband emissive material according to an exemplary embodiment: blue-emitting spirobifluorene units 12 (cf. FIG. 5a), green-emitting phenylene vinylene oligomer units (OPV) 10 (cf. FIG. 5c), and red-emitting units 11 (cf. FIG. 5d). Furthermore, the emissive material comprises covalently coupled hole-transporting units 13 (cf. FIG. 5b).

By variation of the content of the individual chromophores 10, 11, 12, the color location of the emitted light within the area, which is spanned by the color locations of the individual chromophores 10, 11, 12 within the CIE diagram, are set.

To obtain an emissive material, to obtain light with a color location near the white point (0.33; 0.33), for example, about 1% green-emitting OPV units 10 and about 1% red emitting units 11 are covalently coupled to copolymers of blue-emitting spirobifluorene units 12 and hole-transporting units 13. This emissive material may be applied, for example, by means of a printing technique, such as screen printing techniques or spincoating.

The invention for the first time makes available an organic display with color filter technology, which by means of uniform control overcomes the problem of uneven aging of subpixels 2, 3, 4.

The scope of the invention is not limited by the description of the invention with use of the exemplary embodiments. Rather, the invention comprises any new feature and any combination of features, which particularly any combination of features in the claims comprises, even if this combination is not explicitly stated in the patent claims.

What is claimed is:

1. Color organic display (OLED display) with pixels, which comprise a subpixel set with the colors, red, green, and blue, comprising:
a substrate, which is at least partially transparent to visible light,
a structured color filter, which generates the colors of the subpixels and is subsequently arranged on the substrate,
a first electrode on the color filter, which is at least partially transparent to visible light,
at least one active layer on the first electrode, containing an emissive material, which is suitable for the generation of electromagnetic radiation, whose spectrum is matched to the color filter such that the pixels during control with the same electrical signal emit light whose color location lies within the white region of the CIE diagram, and a second electrode arranged on the active layer.

2. The organic display according to claim 1, wherein the emissive material contains polymers with:
first chromophores, which produce a green color impression, and
second chromophores, which produce a red color impression.

3. The organic display according to claim 2, wherein the polymers contain chromophores, which produce a blue color impression.

4. The organic display according to any one of the preceding claims, wherein the first electrode is an anode and comprises indium tin oxide.

5. The organic display according to claim 1, wherein the active layer contains at least one polyspiro compound.

6. The organic display according to claim 1, wherein the active layer contains at least one polyfluorene compound.

7. The organic display according to claim 1, wherein the individual subpixels of the subpixel set have the same lifetime.

8. A method of using an organic display with color filter technology according to claim 1 in electronics.

9. A method of using an organic display with color filter technology according to claim 1 for lighting purposes with adjustable color.

10. The organic display according to claim 1, wherein the at least one active layer comprises a blue-emitting polymer with red chromophores and blue chromophores covalently coupled to the blue-emitting polymer.

11. The organic display according to claim 1, wherein the at least one active layer comprises a blue-emitting polymer blended with red chromophores and blue chromophores.

12. An organic device, comprising:
a substrate that is at least partially transparent to visible light,
a structured colored filter having a plurality of fields, wherein each field corresponds to a colored subpixel, and a red subpixel, a blue subpixel and a green subpixel form a pixel,
a first electrode on the colored filter,
an active layer on the first electrode, comprising an emissive material that is capable of emitting electromagnetic radiation, and
a second electrode on the active layer,
wherein, upon driving the red subpixel, the blue subpixel and the green subpixel with a single selected current, the pixel is a white light pixel.

13. The organic device of claim 12, wherein:
the structured colored filter includes pigments and the emissive material for the blue subpixel is the emissive material for the red subpixel.

14. The organic device of claim 12, wherein the emissive material comprises a blue-emitting polymer with red chromophores and blue chromophores covalently coupled to the blue-emitting polymer.

15. The organic device of claim 12, wherein the emissive material comprises a blue-emitting polymer blended with red chromophores and blue chromophores.

16. The organic device of claim 12, wherein the emissive material comprises a polyspiro compound.

17. The organic device of claim 12, wherein the emissive material comprises a polyfluorene compound.
